(19) United States
(12) Patent Application Publication
(10) Pub. No.: US 2019/0266765 A1
(43) Pub. Date: Aug. 29, 2019

(54) PROCESS MANAGEMENT APPARATUS, PROCESS MANAGEMENT METHOD, AND STORAGE MEDIUM

(71) Applicant: NEC Corporation, Minato-ku, Tokyo (JP)

(72) Inventors: Kazuto OHISHI, Tokyo (JP); Shuji HISHIYAMA, Tokyo (JP); Satoshi MATSUI, Tokyo (JP); Miho YAMADA, Tokyo (JP); Daizaburou SHIRAMIZU, Tokyo (JP); Taisuke NAGANO, Tokyo (JP)

(73) Assignee: NEC Corporation, Minato-ku, Tokyo (JP)

(21) Appl. No.: 16/344,870

(22) PCT Filed: Oct. 5, 2017
(86) PCT No.: PCT/JP2017/036347

§ 371 Date: Apr. 25, 2019

(30) Foreign Application Priority Data
Oct. 28, 2016 (JP) 2016-211551

(51) Int. Cl. G06T 11/20; G06T 11/60; G06T 11/40; G06Q 10/06; G06Q 50/04

(52) U.S. Cl. CPC G06T 11/206; G06T 11/60; G06Q 50/04; G06Q 10/06315; G06T 11/40

(57) ABSTRACT

A process management apparatus of one example embodiment of the invention includes: an acquisition unit that acquires information indicating a time period where a process handling articles is performed as an achievement and a value of the articles handled as an achievement in the process; a generation unit that generates display information used for displaying a first bar A, which has a thickness corresponding to the value of the articles handled as a plan in the process and a height corresponding to a time period in which the process is performed as a plan, and a second bar C, which has a thickness corresponding to the value of the articles handled as the achievement and a height corresponding to a time period where the process is performed as the achievement; and a display control unit that performs control to display the first and second bars based on the display information.

### TECHNICAL FIELD

The present invention relates to an apparatus, a method, and a storage medium that perform process management such as manufacturing, storage, and transportation of a product or the like.

### BACKGROUND ART

In performing processes of manufacturing, storage, and transportation of a product or the like, plans and achievements of respective processes are managed by a manager in general. To manage these processes, a scheme of visually expressing plans and achievements of respective processes by using a table such as a Gantt chart is used. Patent Literature 1 discloses a method of expressing schedules planned for respective processes by using a bar graph and expressing progress statuses by using an overlapped line graph. With such a method, since schedules of plans and achievements of respective processes are visually expressed, the manager is able to more easily recognize the status of respective processes than when only numerical values are used.

### CITATION LIST

### Patent Literature

PTL 1: Japanese Patent Application Laid-Open No. 2015-49710

### SUMMARY OF INVENTION

### Technical Problem

In management of a process of handling articles, not only the schedule but also the quantity of articles is an important factor. In general, a larger quantity of articles handled in a process causes a greater influence when the plan and the achievement are discrepant. Since the method disclosed in Patent Literature 1 is to express the schedule of processes by using a graph, however, it is not possible to reflect the quantity of articles on the graph. Thus, in the method disclosed in Patent Literature 1, when there is a part on the graph where a plan and an achievement is discrepant, what can be directly known from the part is only the discrepancy in the schedule, and the degree of influence cannot be known based on the quantity of articles handled in the process.

The present invention has been made in view of the problem described above and intends to provide a process management apparatus, a process management method, and a storage medium that can display a plan and an achievement of a process based on a quantity (value) of articles handled in the process in addition to time of the process.

### Solution to Problem

A first example aspect of the present invention is a process management apparatus including: an acquisition unit that acquires information indicating a time period in which a process handling articles is performed as an achievement and a value of the articles handled as an achievement in the process; a generation unit that generates display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and a display control unit that performs control to display the first bar and the second bar based on the display information.

A second example aspect of the present invention is a process management method including: acquiring information indicating a time period in which a process handling articles is performed as an achievement and a value of the articles handled as an achievement in the process; generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and performing control to display the first bar and the second bar based on the display information.

A third example aspect of the present invention is a storage medium that causes a computer to execute: acquiring information indicating a time period in which a process handling articles is performed as an achievement and a value of the articles handled as an achievement in the process; generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and performing control to display the first bar and the second bar based on the display information.

### Advantageous Effects of Invention

According to the present invention, it is possible to display a plan and an achievement for time and a quantity (value) of a process by generating a first bar indicating a value and time of a plan by using the thickness and the height and a second bar indicating a value and time of an achievement by using the thickness and the height.

### BRIEF DESCRIPTION OF DRAWINGS

FIG. 1 is a schematic diagram of a process management system according to a first example embodiment.

FIG. 2 is a general configuration diagram of a process management apparatus according to the first example embodiment.

FIG. 3A is a schematic diagram of a process indication bar displayed by the process management apparatus according to the first example embodiment.

FIG. 3B is a schematic diagram of a process indication bar displayed by the process management apparatus according to the first example embodiment.

FIG. 3C is a schematic diagram of a process indication bar displayed by the process management apparatus according to the first example embodiment.

FIG. 4 is a front view of a display displaying process display information according to the first example embodiment

FIG. 5 is a diagram illustrating a flowchart of a process display operation according to the first example embodiment.

FIG. 6 is a schematic diagram of a process indication bar displayed by a process management apparatus according to a second example embodiment.

FIG. 7 is a schematic diagram of a process indication bar displayed by a process management apparatus according to a third example embodiment.

FIG. 8A is a schematic diagram of a process indication bar displayed by a process management apparatus according to a fourth example embodiment.

FIG. 8B is a schematic diagram of a process indication bar displayed by the process management apparatus according to the fourth example embodiment.

FIG. 9 is a schematic diagram of a process indication bar displayed by a process management apparatus according to a fifth example embodiment.

FIG. 10 is a general configuration view of the process management apparatus according to each example embodiment.

### DESCRIPTION OF EMBODIMENTS

While example embodiments of the present invention will be described below with reference to the drawings, the present invention is not limited to these example embodiments. Note that, throughout the drawings described below, components having the same function are labeled with the same references, and the repeated description thereof may be omitted.

### First Example Embodiment

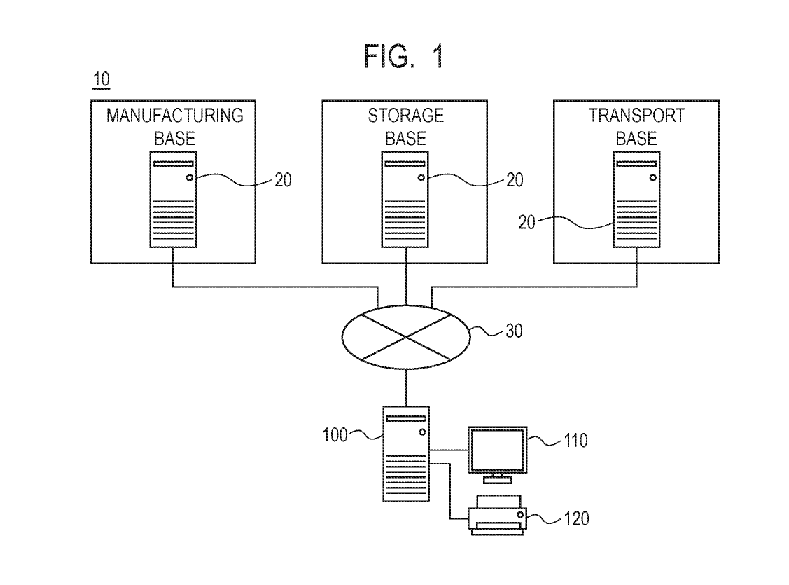

FIG. 1 is a schematic diagram of a process management system 10 according to the present example embodiment. The process management system 10 has a process management apparatus 100 that performs management and display of processes and base management apparatuses 20 provided to respective bases. The bases may include a manufacturing base for manufacturing articles, a storage base for storing articles, and a transport base for transporting articles, for example. The configuration of bases illustrated in FIG. 1 is an example, and the configuration of bases is not limited thereto. Any configuration is possible as long as there is at least one base to which the base management apparatus 20 is provided. There may be a plurality of manufacturing bases, there may be a plurality of storage bases, and there may be a plurality of transport bases, or there may be two or more types of bases as a single base.

The process management apparatus 100 and the base management apparatuses 20 are connected by wired connection or wireless connection via a network 30 such as the Internet. The process management system 10 may include other devices such as a server, a terminal, or the like.

Each of the base management apparatuses 20 is an apparatus that is installed in each base and collects process information including the start time and the end time of a process performed at the base, a quantity of articles handled in the process, or the like. One or a plurality of base management apparatuses 20 are provided in one base. The base management apparatus 20 transmits the collected process information to the process management apparatus 100.

The process management apparatus 100 receives and records process information from the base management apparatuses 20. Further, the process management apparatus 100 generates process display information based on process information through a process display operation described later and outputs the process display information by using a display 110 or a printer 120 connected to the process management apparatus 100.

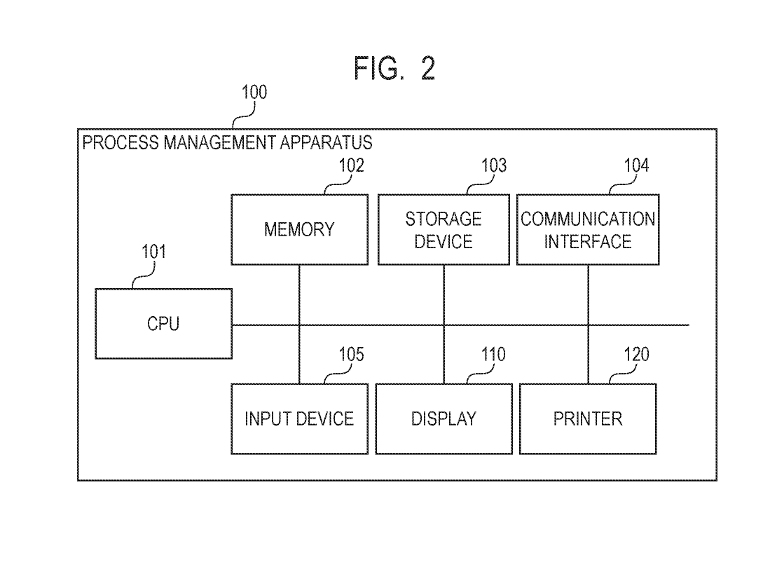

FIG. 2 is a general configuration diagram of the process management apparatus 100 according to the present example embodiment. The process management apparatus 100 has a central processing unit (CPU) 101, a memory 102, a storage device 103, a communication interface 104, and an input device 105 in addition to the display 110 and the printer 120 described above. The process management apparatus 100 is not limited to the configuration illustrated in FIG. 2 but may further have other components. The process management apparatus 100 may include one or a plurality of devices or may be configured integrally with other devices. The base management apparatus 20 may have the same configuration as the process management apparatus 100.

The communication interface 104 is a communication unit that transmits and receives data and is configured to be able to implement a communication scheme of at least one of wired communication and wireless communication. The communication interface 104 includes a processor, an electric circuit, an antenna, a connector terminal, or the like necessary for the communication scheme. The communication interface 104 is connected to the network 30 and performs communication by using the communication scheme in accordance with a signal from the CPU 101.

The storage device 103 stores a program executed by the process management apparatus 100, resulted data processed by the program, or the like. The storage device 103 includes a read-only memory (ROM), a readable and writable hard disk drive or flash memory, or the like. Further, the storage device 103 may include a computer readable portable storage medium such as a CD-ROM. The memory 102 includes a random access memory (RAM) or the like that temporarily stores data being processed by the CPU 101 or data read from the storage device 103.

The CPU 101 is a processor that temporarily stores transitory data used for an operation in the memory 102, reads a program stored in the storage device 103, and performs various processing operations such as calculation, control, determination, or the like on the transitory data in accordance with the program. Further, the CPU 101 stores data of a processing result in the storage device 103 and externally transmits data of a processing result via the communication interface 104.

The input device 105 includes a keyboard or the like used for instruction to perform a process display operation, accepts input from a user, and transmits input contents to the CPU 101 as a signal.

The display 110 is a display device that displays information to the user. Any display device such as a cathode ray tube (CRT) display, a liquid crystal display, or the like may be used as the display 110. The display 110 displays predetermined information such as process display information in accordance with a signal from the CPU 101.

The printer 120 is a printer device that prints predetermined information such as process display information or the like in accordance with a signal from the CPU 101. Any printer device such as a thermal printer, an ink jet printer, a laser printer, or the like may be used as the printer 120.

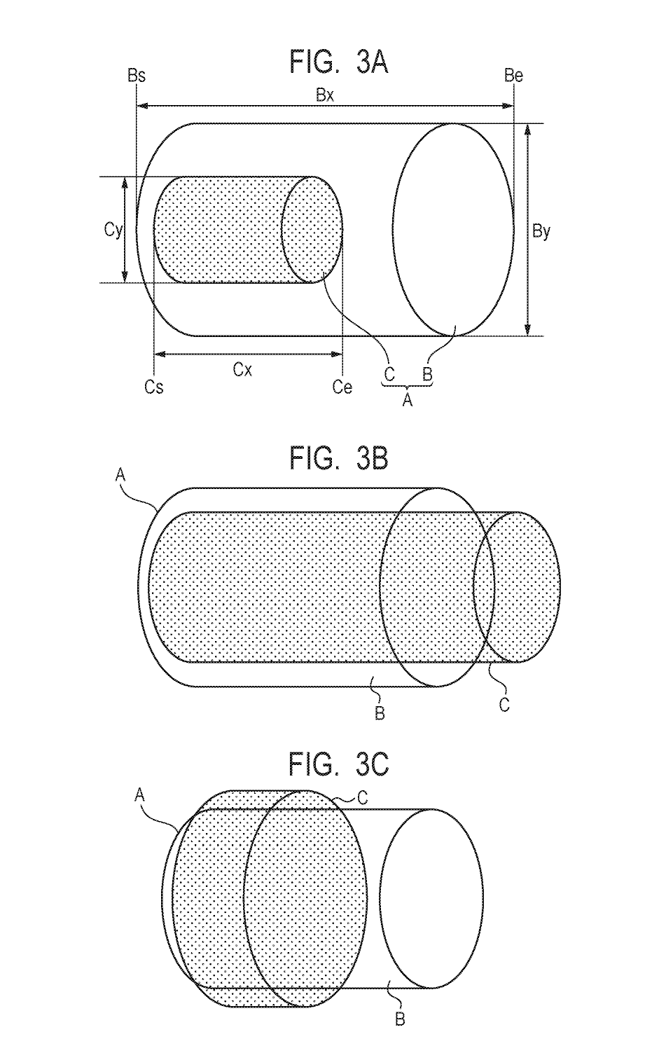

FIG. 3A is a schematic diagram of a process indication bar A displayed by the process management apparatus 100 according to the present example embodiment. The expression of display/indication here means visual indication to the user such as display by the display 110, printing by the printer 120, or the like. The process indication bar A has a reference bar B (first bar) representing a planned quantity and time and an achievement bar C (second bar) representing an achieved quantity and time.

The process indication bar A is set for respective articles handled in a process designated by the user. In other words, a unit represented by one process indication bar A is a combination of one process (for example, a manufacturing process) and one type of article (for example, a manufactured model). A process means work from the start to the completion of an operation of one type of article. That is, work from start of manufacturing the article to the completion thereof is one process in manufacturing, work from the start of transporting the article to the completion of transportation is one process in transportation, and work from the start of storing the article to the completion of the storage is one process in storage. For example, when there are multiple manufacturing lines associated with one type of article in one process, multiple process indication bars A may be set for one type of article. Further, one process indication bar A may be set across multiple processes and multiple types of article. Selection as to which process and article the process indication bar A is set for may be set by the user in advance or may be set automatically by the process management apparatus 100.

The reference bar B has a column-like shape having two bottom faces parallel to each other and a side face connecting the two bottom faces, and the positions of the two bottom faces are referred to as a start end Bs and a completion end Be. The start end Bs corresponds to start time (time of starting work) of a process, the completion end Be corresponds to completion time, and the length from the start end Bs to the completion end Be (that is, a height Bx of the reference bar B) corresponds to a reference time period. The reference time period is a time period (period) in which a process is performed as a plan. That is, the height Bx of the reference bar B is set to be larger for a longer planned time period during which a process is performed and set to be smaller for a shorter planned time period. For example, the height Bx of the reference bar B may be set to be proportional to a planned time period, or may be set to change stepwise in accordance with a planned time period. The rule of the height Bx of the reference bar B in accordance with a planned time period is not limited to that illustrated here but may be determined in any manner and recorded in the process management apparatus 100 in advance.

The diameter of the bottom faces of the reference bar B in the start end Bs and the completion end Be (that is, a thickness By of the reference bar B) corresponds to a capability. A capability (for example, a manufacturing capability, a transport capability, and a storage capacity) is a planned quantity of articles to be handled per unit time (for example, one day) in a process. That is, the thickness By of the reference bar B is set to be larger for a larger planned quantity per unit time of articles to be handled in a process and set to be smaller for a smaller planned quantity. For example, the thickness By of the reference bar B may be set to be proportional to a planned quantity or may be set to change stepwise in accordance with a planned quantity. The rule of the thickness By of the reference bar B in accordance with a planned quantity is not limited to that illustrated here but may be determined in any manner and recorded in the process management apparatus 100 in advance.

The achievement bar C has a column-like shape having two bottom faces parallel to each other and a side face connecting the two bottom faces, and the positions of the two bottom faces are referred to as a start end Cs and a completion end Ce. The start end Cs corresponds to start time (time of starting work) of a process, the completion end Ce corresponds to completion time of the process, and the length from the start end Cs to the completion end Ce (that is, a height Cx of the achievement bar C) corresponds to an achieved time period. The achieved time period is a time period (period) in which a process is performed as an achievement. Note hat, as an achieved time period, a time period from the start of work to the completion thereof is used when the process is completed, and a time period from the start of work to a timing for display is used when the process is ongoing. That is, the height Cx of the achievement bar C may be set to be larger for a longer achieved time period during which a process has been performed and set to be smaller for a shorter achieved time period. For example, the height Cx of the achievement bar C is set to be proportional to an achieved time period, or may be set to change stepwise in accordance with an achieved time period. The rule of the height Cx of the achievement bar C in accordance with an achieved time period is not limited to that illustrated here but may be determined in any manner and recorded in the process management apparatus 100 in advance.

The diameter of the bottom faces of the achievement bar C in the start end Cs and the completion end Ce (that is, a thickness Cy of the achievement bar C) corresponds to an achieved quantity. An achieved quantity is a quantity of articles that have been handled (manufactured, stored, or transported) as achievements per unit time (the same as the unit time used for the capability in the reference bar B) in a process. That is, the thickness Cy of the achievement bar C is set to be larger for a larger achieved quantity per unit time of articles that have been handled in a process and set to be smaller for a smaller achieved quantity. For example, the thickness Cy of the achievement bar C may be set to be proportional to an achieved quantity or may be set to change stepwise in accordance with an achieved quantity. The rule of the thickness Cy of the achievement bar C in accordance with an achieved quantity is not limited to that illustrated here but may be determined in any manner and recorded in the process management apparatus 100 in advance.

As the thicknesses By an Cy of the reference bar B and the achievement bar C, a price (that is, a produce of a unit price and a quantity of articles) may be used instead of planned and achieved quantities. A use of a price of articles allows for easier comparison of a plurality of process indication bars related to articles of different unit prices. Indices that can represent a value of articles handled in a process, such as a quantity and a price of the articles, are here collectively referred to as a value of articles. In other words, a value of articles is calculated based on at least one of the quantity and the price of articles, and the thicknesses By and Cy of the reference bar B and the achievement bar C correspond to the value of articles per unit time. Each of the thicknesses By and Cy is set to be larger for a higher value and set to be smaller for a lower value.

The achievement bar C is displayed to be superimposed on the reference bar B. The reference bar B and the achievement bar C are arranged such that the start end Bs of the reference bar B and the start end Cs of the achievement bar C are close to each other and that the direction from the start end Bs to the completion end Be of the reference bar B and the direction from the start end Cs to the completion end Ce of the achievement bar C are parallel to each other. Since it is difficult to visually distinguish the reference bar B and the achievement bar C from each other if the start end Bs of the reference bar B and the start end Cs of the achievement bar C are completely matched to each other, it is desirable to provide a gap of a predetermined length (for example, 5% or less of the height Bx of the reference bar B) between the start end Bs of the reference bar B and the start end Cs of the achievement bar C.

The reference bar B and the achievement bar C are displayed as a plan view viewed from an oblique direction (neither parallel nor perpendicular direction) relative to the direction from the start ends Bs and Cs to the completion ends Be and Ce (that is, the height direction of the reference bar B and the achievement bar C). This enables the user to easily compare the size of the reference bar B and the size of the achievement bar C.

In other words, the reference bar B and the achievement bar C within FIG. 3A are displayed as perspective view images.

The appearance such as the color, the pattern, or the like of the reference bar B and the achievement bar C is displayed to be different from each other. This enables the user to easily distinguish the reference bar B and the achievement bar C from each other. Further, a text such as “reference” or “achievement” for distinguishing the reference bar B from the achievement bar C may be provided inside or near the reference bar B and the achievement bar C.

FIG. 3B and FIG. 3C illustrate exemplary process indication bars A. In the process indication bar A of FIG. 3B, the thickness Cy of the achievement bar C is displayed thinner than the thickness By of the reference bar B, and the height Cx of the achievement bar C is displayed longer than the height Bx of the reference bar B. Thus, it is easily understood in the process of FIG. 3B that the achievement quantity per unit time is less than the planned quantity and that the achieved time period is longer than the planned time period. In the process indication bar A of FIG. 3C, the thickness Cy of the achievement bar C is displayed thicker than the thickness By of the reference bar B, and the height Cx of the achievement bar C is displayed shorter than the height Bx of the reference bar B. Thus, it is easily understood in the process of FIG. 3C that the achievement quantity per unit time is greater than the planned quantity and that the achieved time period is shorter than the planned time period.

With such a display method, the difference in shape between the reference bar B and the achievement bar C is displayed to be larger for a larger difference between a plan and an achievement with respect to at least one of a quantity (value) of articles handled in a process and a time period of the process. Thus, from the appearance of the process indication bar A, the user is able to visually recognize the difference between a plan and an achievement of a process with respect to a quantity in addition to a time period.

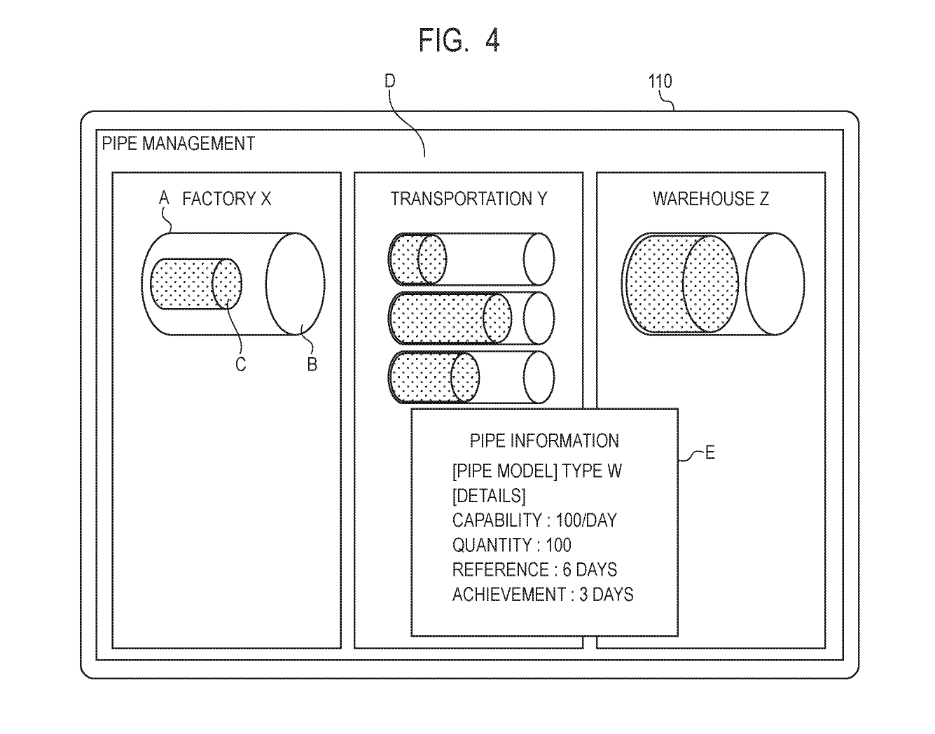

FIG. 4 is a front view of the display 110 displaying process display information D according to the present example embodiment. The process display information D includes at least one process indication bar A. The output of the process display information D may be performed in any manner that can visually indicate the output to the user, such as printing by the printer 120, without being limited to display on a screen by using the display 110.

The process management apparatus 100 accepts designation of a process (a process of transportation Y in this example) via the input device 105 from the user and displays all the process indication bars A associated with the process so as to be arranged vertically inside the process display information D.

Furthermore, the process management apparatus 100 displays the process indication bars A associated with processes performed before and after the designated process (the process in a factory X and the process in a warehouse Z in this example) so as to be arranged in the horizontal direction of the process indication bar A associated with the designated process. The relationship between processes (that is, the sequence relationship between processes) is defined and recorded in the process management apparatus 100 in advance. To maintain the integrity of displayed contents, the process indication bars A displayed at the same time for the designated process and the preceding and subsequent processes are generated from process information related to the same timing (for example, designated time or time of the end of a day).

With the process indication bars A of the process designated by the user and the preceding and subsequent processes being arranged and displayed as discussed above, the user is able to overview the process indication bars A of the mutually associated processes all at once, which allows for easier analysis of processes.

In FIG. 4, the process indication bars A related to a designated process are arranged vertically and displayed, and the process indication bars A related to the preceding and subsequent processes are arranged horizontally and displayed. Without being limited thereto, the process indication bars A for a designated process and the process indication bars A for the preceding and subsequent processes may be arranged in any manner as long as these process indication bars A are arranged in different directions, such as a manner in which the process indication bars A related to a designated process may be arranged horizontally and the process indication bars A related to the preceding and subsequent processes may be arranged vertically.

Further, the process management apparatus 100 accepts designation of a process indication bar A via the input device 105 from the user and displays detailed information E on the designated process indication bar A in the upper part of or near the process indication bar A. The detailed information E includes, for example, the model name of article (type), a reference time period, an achieved time period, a capability, and an achieved quantity related to the process indication bar A. Alternatively, the detailed information E may further include a value indicating the ratio of the difference in size between the reference bar B and the achievement bar C. The detailed information E may be displayed in the process display information D related to all the process indication bars A when being displayed without designation of the process indication bar A received from the user. While the specific example for the detailed information E has been described in the present example embodiment, the detailed information E is not limited thereto. For example, when the process indication bar A indicates information on transportation, the detailed information E may further include information indicating a name of delivery, departure date and time of delivery, or expected arrival date and time of delivery. Further, for example, when the process indication bar A indicates information on a warehouse, the detailed information E may further include a name of the warehouse or a storage location (location information).

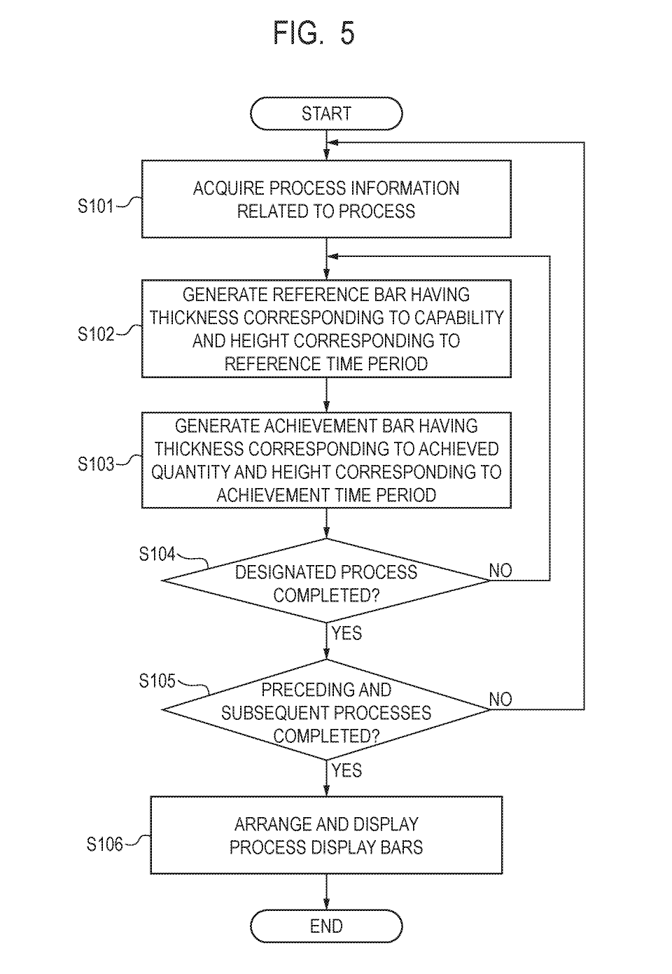

FIG. 5 is a diagram illustrating a flowchart of a process display operation performed in the process management method according to the present example embodiment. The process display operation is performed by the process management apparatus 100. The process display operation is started by the user performing an operation of designating a target process for the process display from the input device 105 of the process management apparatus 100, for example.

First, the process management apparatus 100 receives and acquires process information targeted for the designated process from the base management apparatus 20 (step S101). The process information may be received from the base management apparatus 20 every time the process display operation is performed, or may be read from process information recorded within the process management apparatus 100 that has been received from the base management apparatus 20 in advance.

Next, the process management apparatus 100 generates information used for displaying the column-like reference bar B having a thickness corresponding to the capability of handling articles in a process (that is, a planned quantity of articles handled per unit time) and a height corresponding to a reference time period of the process (that is, a planned time period) from the process information acquired in step S101 (step S102).

Next, the process management apparatus 100 generates information used for displaying the column-like achievement bar C having a thickness corresponding to the achieved quantity of articles handled per unit time in the process and a height corresponding to the achieved time period of the process from the process information acquired in step S101 (step S103).

The process management apparatus 100 temporarily stores, in the memory 102, information used for displaying the process indication bar A including the reference bar B and the achievement bar C generated in steps S102 to S103.

If generation of information used for displaying the process indication bar A is not completed for all the articles related to one process (step S104, NO), steps S102 to S103 are repeated for the next article related to the process. If generation of information used for displaying the process indication bar A is completed for all the articles related to one process (step S104, YES), the operation proceeds to the next step S105.

If generation of information used for displaying the process indication bar A is not completed for the processes preceding and subsequent to the designated process (step S105, NO), steps S101 to S103 are repeated for the processes preceding and subsequent to the designated process as targets.

If generation of information used for displaying the process indication bar A is completed for the processes preceding and subsequent to the designated process (step S105, YES), the process management apparatus 100 reads information used for displaying the process indication bar A from the memory 102 and performs control for displaying the process indication bar A including the reference bar B and the achievement bar C generated in steps S102 to S103 by using the display 110, the printer 120, or the like (step S106). Specifically, as illustrated in FIG. 4 as an example, the process management apparatus 100 displays the process indication bars A related to the designated process so as to be arranged vertically, and further displays the process indication bars A related to the processes preceding and subsequent to the designated process so as to be arranged horizontally. At this time, the process management apparatus 100 displays the reference bar B and the achievement bar C in the appearance different from each other.

In the present example embodiment, the CPU 101 of the process management apparatus 100 is an operating subject of each step (process) included in the operation illustrated in FIG. 5. Specifically, the CPU 101 functions as an acquisition unit that performs step S101, a generation unit that performs steps S102 to S103, and a display control unit that performs step S106. The CPU 101 reads a program used for executing the operation illustrated in FIG. 5 from the memory 102 or the storage device 103 and performs the operation illustrated in FIG. 5 by executing the program to control each unit of the process management apparatus 100. Further, at least a part of the operation illustrated in FIG. 5 may be performed by a dedicated device or electric circuit rather than the CPU 101.

According to the process management apparatus 100 of the present example embodiment, a quantity (value) and a time period are represented in a bar-like manner for planned and achieved processes. Such a configuration enables the user to easily recognize the difference between plans and achievements from both the aspects of a quantity and a time period.

### Second Example Embodiment

While a single pair of the reference bar B and the achievement bar C are included in a single process indication bar A in the first example embodiment, multiple pairs of the reference bar B and the achievement bar C are included in a single process indication bar A in the present example embodiment. In the present example embodiment, the process management apparatus 100 and the base management apparatuses 20 having the same configuration as that in the first example embodiment are used.

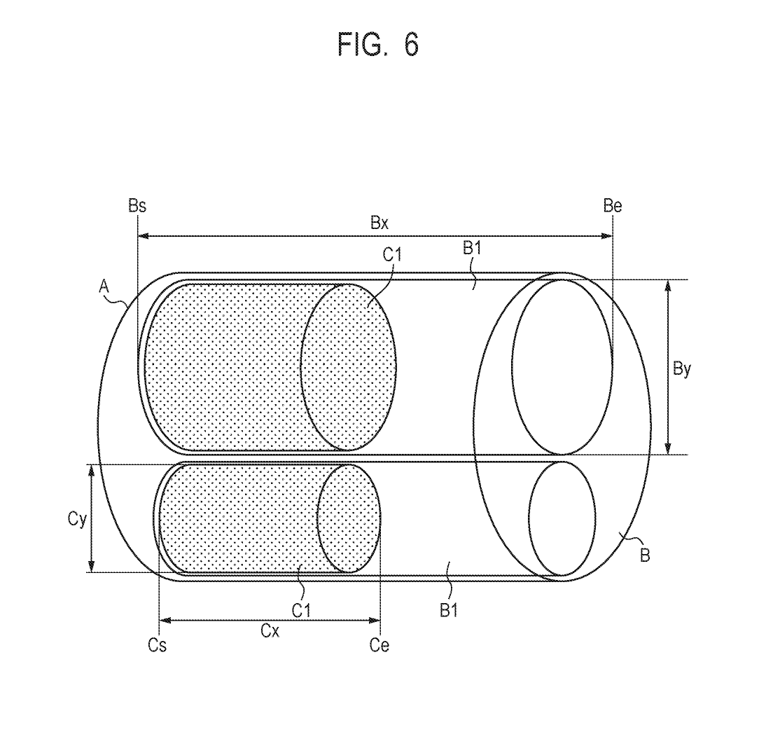

FIG. 6 is a schematic diagram of the process indication bar A displayed by the process management apparatus 100 according to the present example embodiment. The process indication bar A has one reference bar B representing a quantity and a time period of the entire plan. Further, the reference bar B has multiple pairs of child reference bars B1 (third bars) each representing a quantity and a time period of an individual plan and the child achievement bars C1 (fourth bars) each representing a quantity and a time period of an individual achievement.

Each pair of the child reference bar B1 and the child achievement bar C1 is displayed in the same manner as the reference bar B and the achievement bar C of the first example embodiment. Each pair of the child reference bar B1 and the child achievement bar C1 is associated with a line (a manufacturing line or the like), for example, and represents a reference time period, an achieved time period, a capability, and an achieved quantity of the line. The child reference bar B1 has a height Bx corresponding to a reference time period and a thickness By corresponding to a capability in the same manner as the reference bar B. The child achievement bar C1 has a height Cx corresponding to an achieved time period and a thickness Cy corresponding to an achieved quantity in the same manner as the achievement bar C. In other words, a plurality of child reference bars B1 included in one reference bar B always represent the same reference time period but represent the same or a different capability. Further, a plurality of child achievement bars C1 included in one reference bar B always represent the same achieved time but represent the same or a different achieved quantity.

The reference bar B, the child reference bars B1, and the child achievement bars C1 are displayed as plan views viewed from an oblique direction relative to a direction from the start ends Bs and Cs to the completion ends Be and Ce, respectively.

The process indication bar A according to the present example embodiment has two-stage multiple structure or may have three or more-stage multiple structure in which multiple pairs of the child reference bar B1 and the child achievement bar C1 are further included in the child reference bar B1.

According to the configuration of the present example embodiment, the same advantage as that of the first example embodiment can be obtained, and since the process indication bar A can have the multiple structure, more various information can be expressed. More specifically, the present example embodiment is applicable to a case where particular articles are manufactured in two manufacturing lines in a manufacturing factory, for example. In such a case, the process management apparatus 100 can present, to the user, manufacturing statuses of individual manufacturing lines by using a pair of the child reference bar B1 and the child achievement bar C1 for each of the manufacturing lines as described above. Further, the process management apparatus 100 can present, to the user, a manufacturing status of the entire manufacturing lines by using a pair of the reference bar B and the achievement bar C. This enables the user to recognize both the manufacturing status of particular articles and the manufacturing status of an individual manufacturing line simultaneously and easily.

### Third Example Embodiment

While the column-like reference bar B and the column-like achievement bar C are displayed in the first example embodiment, a planar reference bar B and a planar achievement bar C are displayed in the present example embodiment. In the present example embodiment, the process management apparatus 100 and the base management apparatuses 20 having the same configuration as that in the first example embodiment are used.

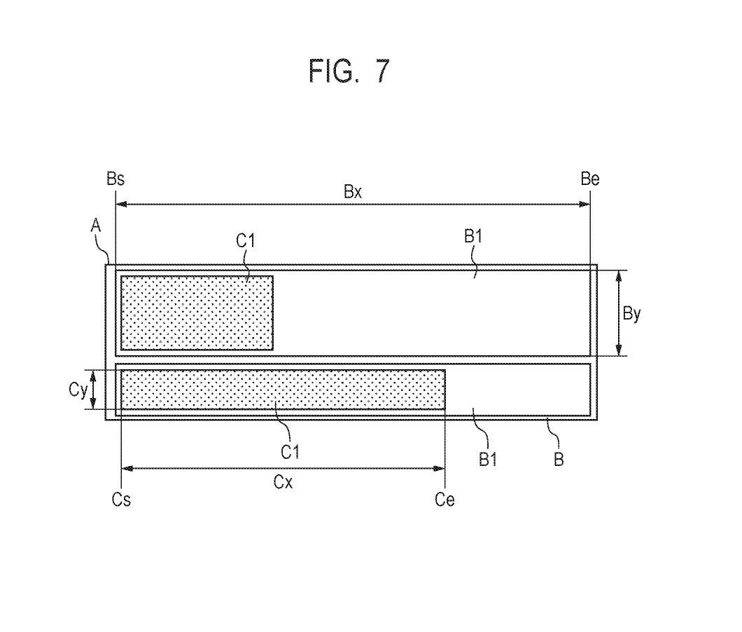

FIG. 7 is a schematic diagram of the process indication bar A displayed by the process management apparatus 100 according to the present example embodiment. The process indication bar A according to the present example embodiment corresponds to the process indication bar A illustrated in FIG. 6 when expressed on a plane. Specifically, the reference bar B, the child reference bar B1, and the child achievement bar C1 are displayed as plan views viewed from a direction perpendicular to the direction from the start ends Bs and Cs to the completion ends Be and Ce, respectively. The process indication bar A can represent a time period and a quantity of a plan and an achievement by way of such an expression scheme.

### Fourth Example Embodiment

While the column-like reference bar B and achievement bar C are displayed in the first example embodiment, stepwise reference bar B and achievement bar C are displayed in the present example embodiment. In the present example embodiment, the process management apparatus 100 and the base management apparatuses 20 having the same configuration as that in the first example embodiment are used.

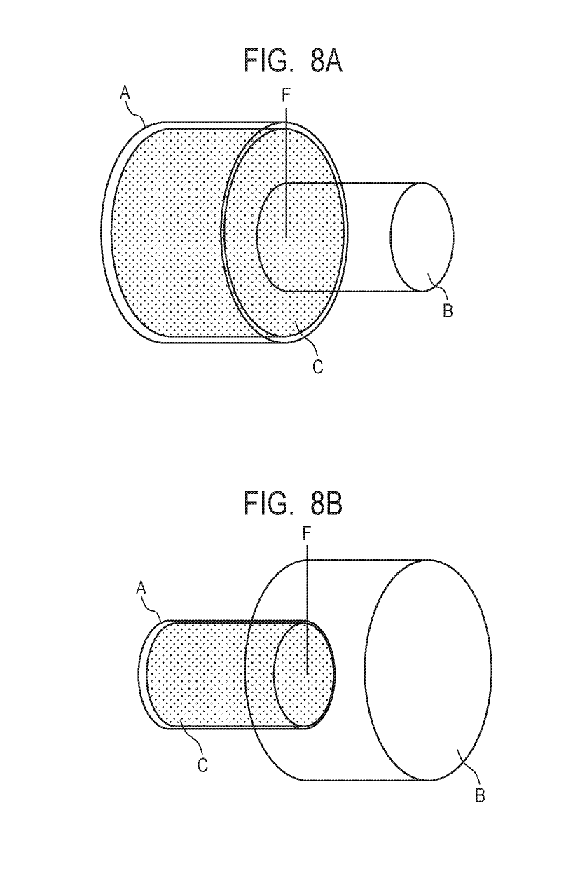

FIG. 8A and FIG. 8B are schematic diagrams of process indication bars A displayed by the process management apparatus 100 according to the present example embodiment. In the first example embodiment, since the thicknesses By and Cy of the reference bar B and the achievement bar C are constant along the time axis (in the direction of the heights Bx and Cx), the reference bar B and the achievement bar C form a column shape. In contrast, in the present example embodiment, different thicknesses By and Cy are set for sections before and after a predetermined timing F on the time axis located between the start end Bs, Cs corresponding the start time and the completion end Be, Ce corresponding to the completion time. In other words, the reference bar B and the achievement bar C are displayed so that the quantity (the capability or the achieved quantity) changes in the middle of the time sequence of a process.

In the example of FIG. 8A, the thicknesses By and Cy of the section before the timing F (closer side to the start ends Bs and Cs) are larger than the thicknesses By and Cy of the section after the timing F (closer side to the completion ends Be and Ce). Thus, the process indication bar A of FIG. 8A indicates that the quantity of articles handled in the process becomes smaller after predetermined time has elapsed from the start time.

In the example of FIG. 8B, the thicknesses By and Cy of the section before the timing F are smaller than the thicknesses By and Cy of the section after the timing F. Thus, the process indication bar A of FIG. 8B indicates that the quantity of articles handled in the process becomes larger after predetermined time has elapsed from the start time.

The timing F at the change of the thicknesses By and Cy may occur for multiple times without being limited to once between the start end Bs, Cs corresponding to the start time and the completion end Be, Ce corresponding to the completion time.

As discussed above, by using the stepwise process indication bar A, it is possible to indicate that a quantity (value) per unit time changes in the middle of a process in an easily understandable manner for the user.

### Fifth Example Embodiment

In the present example embodiment, the display form of the process indication bar A is changed based on the difference in size between the reference bar B and the achievement bar C. In the present example embodiment, the process management apparatus 100 and the base management apparatuses 20 having the same configuration as that in the first example embodiment are used.

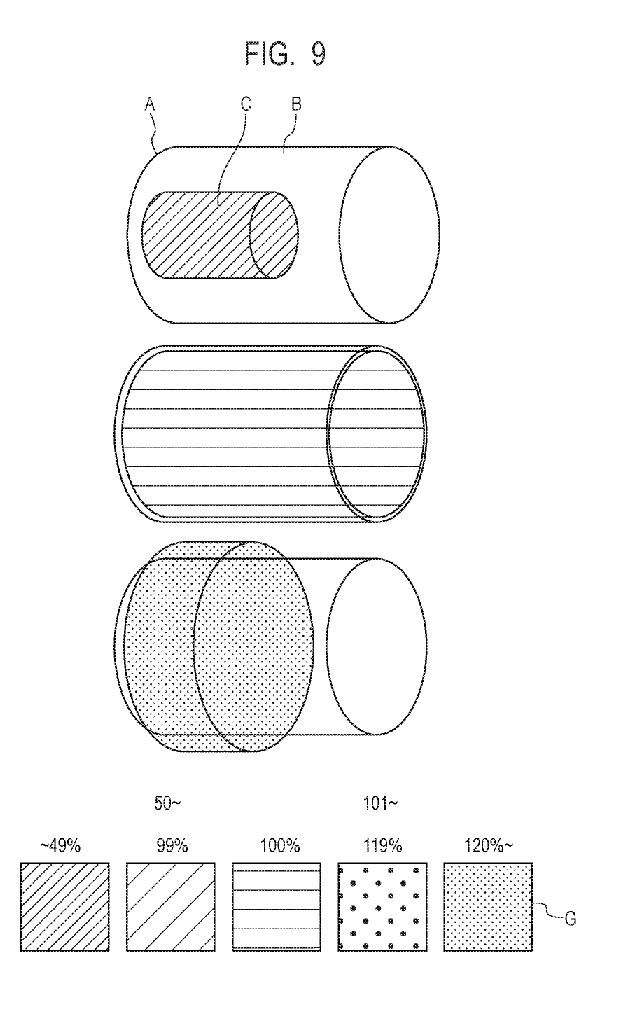

FIG. 9 is a schematic diagram of the process indication bar A displayed by the process management apparatus 100 according to the present example embodiment. In the present example embodiment, the appearance such as the color, the pattern, or the like of at least one of the reference bar B and the achievement bar C is changed based on the difference in size between the reference bar B and the achievement bar C. The difference in size between the reference bar B and the achievement bar C corresponds to the difference between numeric values indicated by the reference bar B and the achievement bar C. Specifically, the process management apparatus 100 calculates a ratio of an achieved quantity per unit time indicated by the achievement bar C to the capability indicated by the reference bar B, determines which of appearance the calculated ratio corresponds to in accordance with a predetermined rule, and displays the achievement bar C with the determined appearance. For example, in the rule for appearance, predetermined appearance is defined in accordance with the degree and the direction (positive direction or negative direction) with which the numeric value of the achievement bar C is deviated from the numeric value of the reference bar B. The rule of appearance corresponding to a ratio is recorded in the process management apparatus 100 in advance, and appearance G for each range of a ratio is indicated near the process indication bar A, for example.

As a numeric value that is a reference of appearance, not only a quantity (value) but also a time period may be used. In this case, the appearance of the achievement bar C may be changed based on a product of a quantity and a time period. While the appearance of the achievement bar C is changed in FIG. 9, the appearance of the reference bar B may be changed.

For example, in the present example embodiment, at least one of the reference bar B and the achievement bar C may be displayed with emphasis based on the difference in size between the reference bar B and the achievement bar C. More specifically, when the difference between the sizes calculated for a targeted reference bar B and a targeted achievement bar C exceeds a predetermined reference (threshold), the process management apparatus 100 may display and emphasize at least one of the targeted reference bar B and the targeted achievement bar C compared to other sets of the reference bar B and the achievement bar C.

Although the appearance of the reference bar B and the achievement bar C is changed in the example of FIG. 9, the display form of the reference bar B and the achievement bar C may be changed so as to reflect the difference between the sizes thereof. For example, the background color of a region including the reference bar B and the achievement bar C may be changed, a line surrounding the region may be displayed, or the region may be blinked based on the difference in size between the reference bar B and the achievement bar C.

With the display form of the process indication bar A being changed based on the difference in size between the reference bar B and the achievement bar C as described above, the user can easily recognize by what degree an achieved value deviates from a reference value (planned value) by simply viewing the process indication bar A.

### Other Example Embodiments

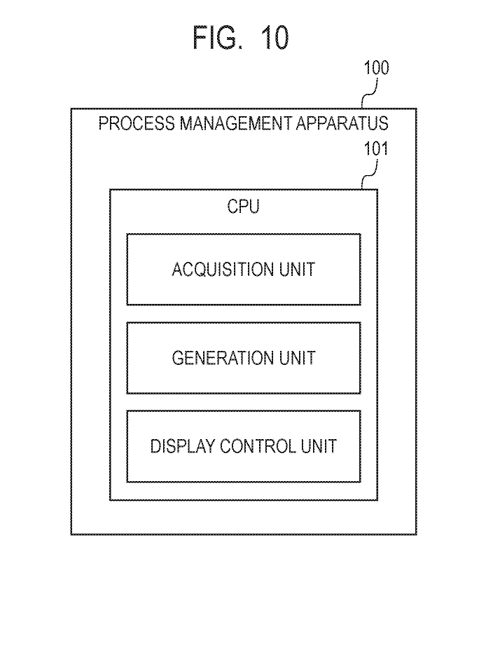

FIG. 10 is a general configuration diagram of the process management apparatus 100 according to each example embodiment described above. FIG. 10 illustrates a configuration example by which the process management apparatus 100 functions as an apparatus that displays a plan and an achievement of a process based on a quantity (value) of articles handled in the process in addition to a time period of the process. The process management apparatus 100 has the CPU 101 that operates: an acquisition unit that acquires information indicating a time period where a process handling articles is performed as an achievement and a value of the articles handled as an achievement in the process; a generation unit that generates display information used for displaying a first bar that has a thickness corresponding to the value of the articles handled as a plan in the process and a height corresponding to a time period in which the process is performed as a plan and a second bar that has a thickness corresponding to the value of the articles handled as the achievement and a height corresponding to a time period where the process is performed as the achievement; and a display control unit that performs control to display the first bar and the second bar based on the display information.

The present invention is not limited to the example embodiments described above and may be changed as appropriate within a scope not departing from the spirit of the present invention.

A processing method that stores a program that operates the configuration of the example embodiment to implement the function of each example embodiment described above (for example, a program that causes the process management apparatus 100 to perform the operation illustrated in FIG. 5) in a storage medium, reads the program recorded in the storage medium as a code, and executes it in a computer is also included in the scope of each example embodiment. That is, a computer readable storage medium is also included in the scope of each example embodiment. Further, not only the storage medium in which the computer program described above is stored but also the computer program itself is included in each example embodiment.

As the storage medium, for example, a floppy (registered trademark) disk, a hard disk, an optical disk, a magneto-optical disk, a CD-ROM, a magnetic tape, a non-volatile memory card, or a ROM may be used. Further, without being limited to one executing the operation with only the program stored in the storage medium, those operating on an OS to execute the operation in corporation with other software or the function of an extension board is included in the scope of each example embodiment.

The whole or part of the example embodiments disclosed above can be described as, but not limited to, the following supplementary notes.

(Supplementary Note 1)

A process management apparatus comprising:

an acquisition unit that acquires information indicating a time period in which a process handling articles is performed as an achievement and a value of the articles handled as an achievement in the process;

a generation unit that generates display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and

a display control unit that performs control to display the first bar and the second bar based on the display information.

(Supplementary Note 2)

The process management apparatus according to supplementary note 1, wherein the display control unit performs the control so as to display the first bar and the second bar to overlap each other based on the display information.

(Supplementary Note 3)

The process management apparatus according to supplementary note 1 or 2,

wherein the generation unit generates the first bar and the second bar for the process and generates the first bar and the second bar for a process preceding to the process and/or the first bar and the second bar for a process subsequent to the process, and

wherein the display control unit performs the control so that the first bar and the second bar for the process preceding to the process and/or the first bar and the second bar for the process subsequent to the process are arranged to the first bar and the second bar for the process and displayed.

(Supplementary Note 4)

The process management apparatus according to any one of supplementary notes 1 to 3, wherein the display control unit performs the control so as to change a display form of at least one of the first bar and the second bar based on a difference in size between the first bar and the second bar.

(Supplementary Note 5)

The process management apparatus according to any one of supplementary notes 1 to 4,

wherein the generation unit further generates display information used for displaying multiple pairs of third bars and fourth bars, each of the third bars has a thickness corresponding to a value of the articles handled as the plan and a height corresponding to a time period scheduled as the plan, and each of the fourth bars has a thickness corresponding to a value of the article handled as the achievement and a height corresponding to a time period achieved as the achievement, and

wherein the display control unit performs the control so as to display the multiple pairs of the third bars and the fourth bars to overlap the single first bar.

(Supplementary Note 6)

The process management apparatus according to supplementary note 5,

wherein, in the multiple pairs, time periods scheduled as the plan represented by the plurality of third bars are the same as each other, and values of the articles handled as the plan represented by the plurality of third bars are the same as each other or different from each other, and

wherein, in the multiple pairs, time periods achieved as the achievement represented by the plurality of fourth bars are the same as each other, and values of the articles handled as the achievement represented by the plurality of fourth bars are the same as each other or different from each other.

(Supplementary Note 7)

The process management apparatus according to any one of supplementary notes 1 to 6, wherein the value is calculated based on at least one of a quantity of the articles and a price of the articles.

(Supplementary Note 8)

The process management apparatus according to any one of supplementary notes 1 to 7,

wherein each of the first bar and the second bar has a column-like shape, and

wherein the display control unit performs the control so that the first bar and the second bar are displayed as viewed from an oblique direction relative to a height direction of the first bar and the second bar.

(Supplementary Note 9)

A process management method comprising:

acquiring information indicating a time period in which a process handling articles is performed as an achievement and a value of the articles handled as an achievement in the process;

generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and

performing control to display the first bar and the second bar based on the display information.

(Supplementary Note 10)

A storage medium in which a program is stored, the program causing a computer to execute:

acquiring information indicating a time period in which a process handling articles is performed as an achievement and a value of the articles handled as an achievement in the process;

generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and

performing control to display the first bar and the second bar based on the display information.

This application is based upon and claims the benefit of priority from Japanese Patent Application No. 2016-211551, filed on Oct. 28, 2016, the disclosure of which is incorporated herein in its entirety by reference.

### REFERENCE SIGNS LIST

10 process management system
20 base management apparatus
30 network
100 process management apparatus
101 CPU
102 memory
103 storage device
104 communication interface
105 input device
110 display
120 printer

What is claimed is:

1. A process management apparatus comprising:
an acquisition unit that acquires information indicating a time period in which a process handling articles is performed as an achievement and a value of the articles handled as an achievement in the process;
a generation unit that generates display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and
a display control unit that performs control to display the first bar and the second bar based on the display information.

2. The process management apparatus according to claim 1, wherein the display control unit performs the control so as to display the first bar and the second bar to overlap each other based on the display information.

3. The process management apparatus according to claim 1,
wherein the generation unit generates the first bar and the second bar for the process and generates the first bar and the second bar for a process preceding to the process and/or the first bar and the second bar for a process subsequent to the process, and
wherein the display control unit performs the control so that the first bar and the second bar for the process preceding to the process and/or the first bar and the second bar for the process subsequent to the process are arranged to the first bar and the second bar for the process and displayed.

4. The process management apparatus according to claim 1, wherein the display control unit performs the control so as to change a display form of at least one of the first bar and the second bar based on a difference in size between the first bar and the second bar.

5. The process management apparatus according to claim 1,
wherein the generation unit further generates display information used for displaying multiple pairs of third bars and fourth bars, each of the third bars has a thickness corresponding to a value of the articles handled as the plan and a height corresponding to a time period scheduled as the plan, and each of the fourth bars has a thickness corresponding to a value of the article handled as the achievement and a height corresponding to a time period achieved as the achievement, and
wherein the display control unit performs the control so as to display the multiple pairs of the third bars and the fourth bars to overlap the single first bar.

6. The process management apparatus according to claim 5,
wherein, in the multiple pairs, time periods scheduled as the plan represented by the plurality of third bars are the same as each other, and values of the articles handled as the plan represented by the plurality of third bars are the same as each other or different from each other, and
wherein, in the multiple pairs, time periods achieved as the achievement represented by the plurality of fourth bars are the same as each other, and values of the articles handled as the achievement represented by the plurality of fourth bars are the same as each other or different from each other.

7. The process management apparatus according to claim 1, wherein the value is calculated based on at least one of a quantity of the articles and a price of the articles.

8. The process management apparatus according to claim 1,
wherein each of the first bar and the second bar has a column-like shape, and
wherein the display control unit performs the control so that the first bar and the second bar are displayed as viewed from an oblique direction relative to a height direction of the first bar and the second bar.

9. A process management method comprising:
acquiring information indicating a time period in which a process handling articles is performed as an achievement and a value of the articles handled as an achievement in the process;
generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and
performing control to display the first bar and the second bar based on the display information.

10. A non-transitory storage medium in which a program is stored, the program causing a computer to execute:
acquiring information indicating a time period in which a process handling articles is performed as an achievement and a value of the articles handled as an achievement in the process;
generating display information used for displaying a first bar, which has a thickness corresponding to the value of the articles handled as a plan in the process and a height corresponding to a time period in which the process is performed as a plan, and a second bar, which has a thickness corresponding to the value of the articles handled as the achievement and a height corresponding to a time period in which the process is performed as the achievement; and
performing control to display the first bar and the second bar based on the display information.
